(19) United States
(12) Patent Application Publication
(10) Pub. No.: US 2025/0296112 A1
(43) Pub. Date: Sep. 25, 2025

(54) Gutter Guard

(71) Applicant: James Frank Beardslee, Sedgwick, KS (US)

(72) Inventor: James Frank Beardslee, Sedgwick, KS (US)

(21) Appl. No.: 19/086,017

(22) Filed: Mar. 20, 2025

Related U.S. Application Data
(60) Provisional application No. 63/567,835, filed on Mar. 20, 2024.

(51) Int. Cl. B05C 21/00

(52) U.S. Cl. CPC B05C 21/005

(57) ABSTRACT

A guard to protect ones already existing gutter is disclosed. The guard has a multiple panel construction to it that bears a plurality of handles. The handles allow the guard to be slid across ones already exiting gutter to protect it from being painted when a painter is seeking to paint a house. The panel has a bottom lip that slides up between the existing gutter and the side of a house and a top lip that securely fastens the guard to the already existing gutter. The guard bears several panels that wrap itself around the gutter to ensure it fits a variety of sized gutters.

### FIELD OF THE INVENTION

The present invention relates generally to painting guards. More specifically, the present invention is a gutter guard for use when painting.

### BACKGROUND OF THE INVENTION

Often times one may need to repaint their house. This can be a daunting and exhausting task, especially as one need to ensure they do not get paint on the gutter and that the paint only gets on the facia of the house. In order to ensure there is no paint transfer, one must be very careful and not work too fast, causing them to make careless movements with the brush which would result in paint being applied to the gutter. One may also have to use a smaller paintbrush with smaller strokes to be sure to keep the paint only on the residence.

An object of the present invention, is provide home repair professionals and painters a device to protect the gutter while painting, in order to be able to move expeditiously in painting while ensuring no paint gets on the gutter. The painting guard is designed to fit over a gutter and has a hook on the bottom of the painting guard to allow it to be clipped up around the bottom of the gutter and a lip that allows it to attach to the gutter on top of the gutter.

### BRIEF DESCRIPTION OF THE DRAWINGS

FIG. 1 shows a prospective view of the present invention.

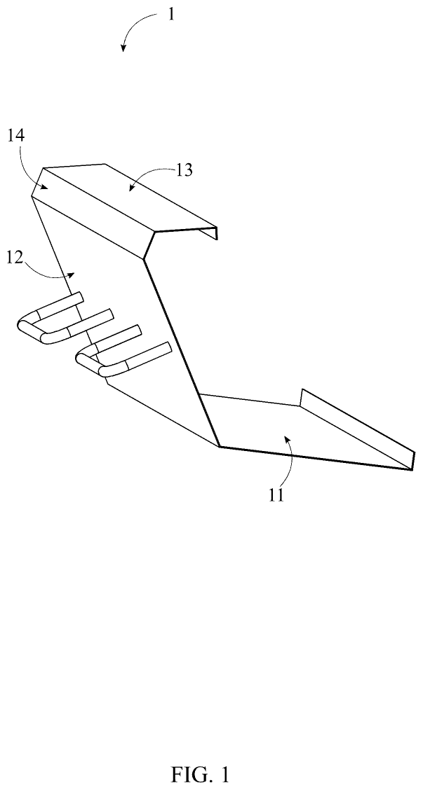

FIG. 2 shows a top prospective view of the present invention.

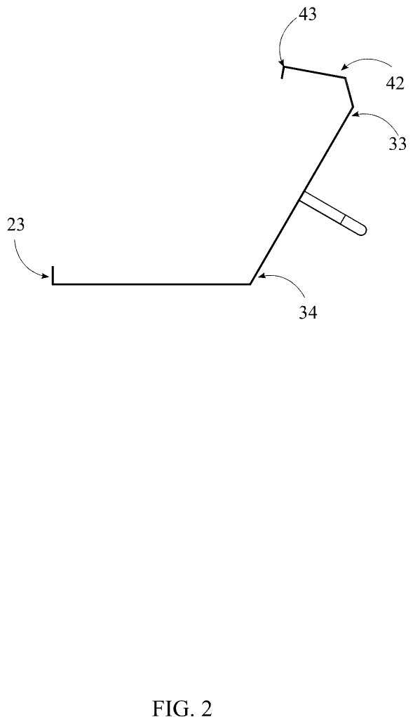

FIG. 3 shows a bottom elevational view of the present invention.

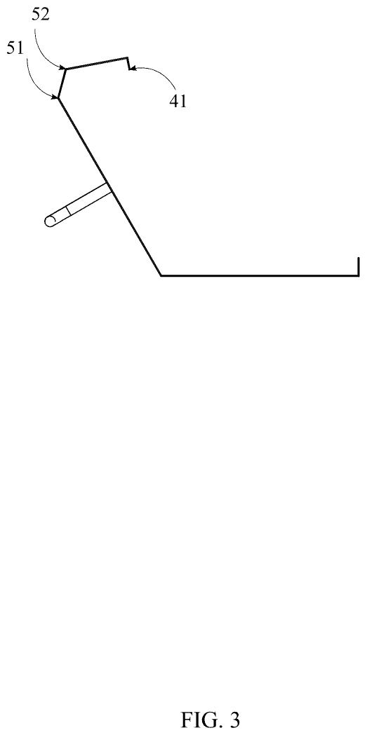

FIG. 4 shows a right view of the present invention.

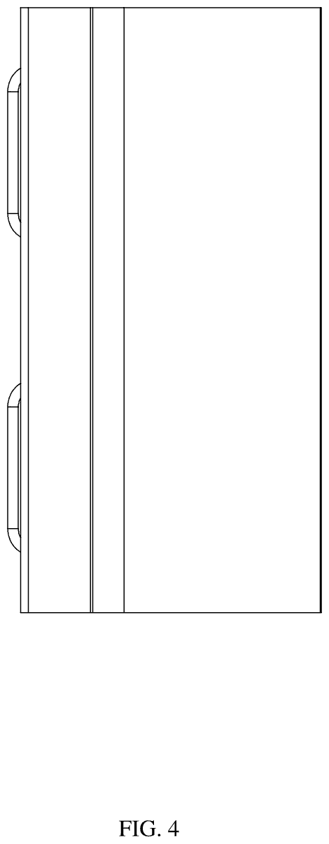

FIG. 5 shows a left view of an embodiment of the present invention.

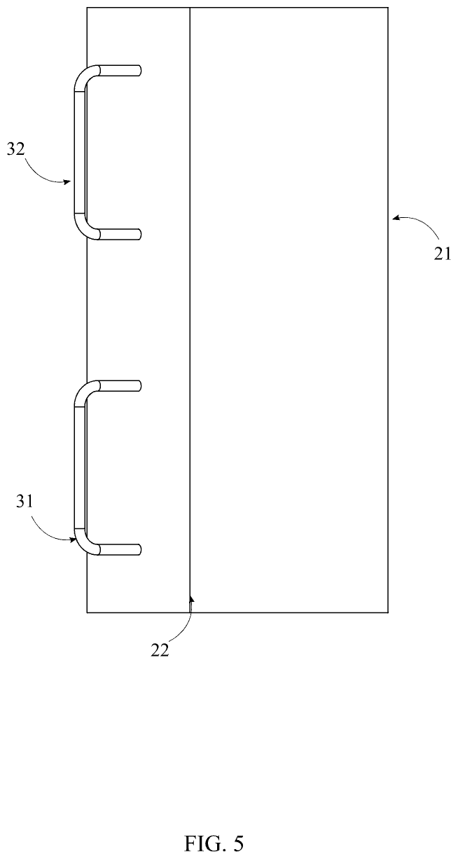

FIG. 6 shows a rear view of the present invention.

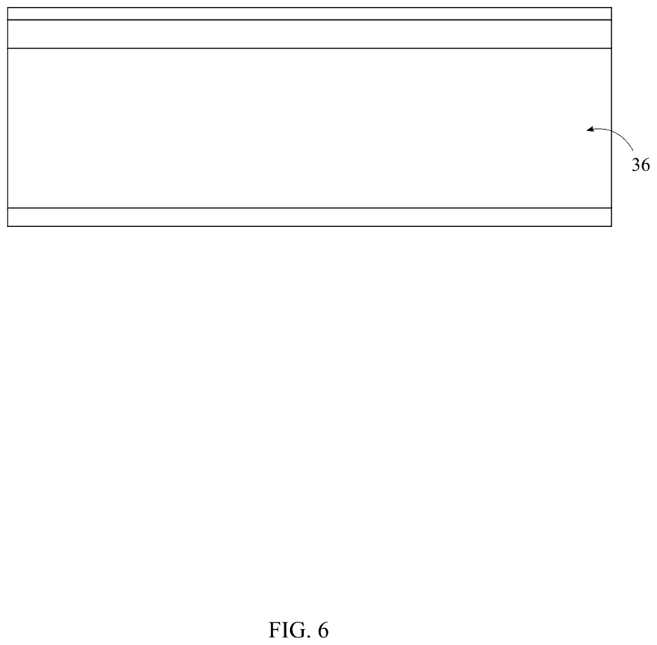

FIG. 7 shows a front view of the present invention.

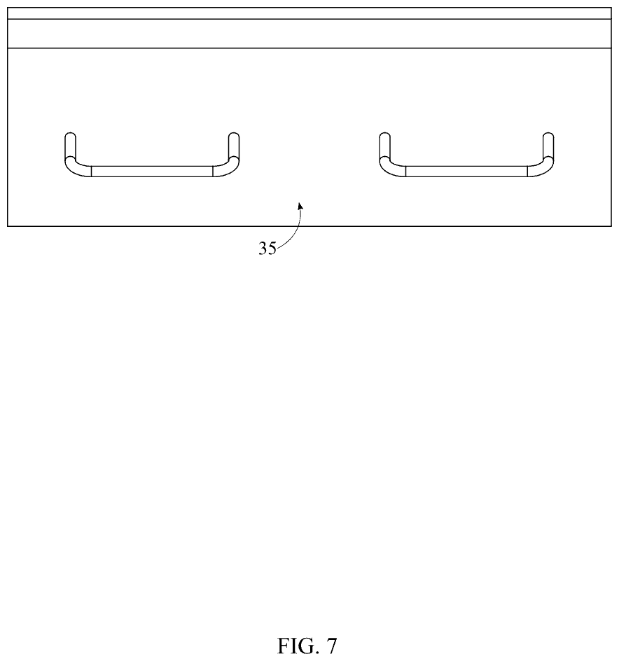

### DETAIL DESCRIPTIONS OF THE INVENTION

The present invention is guard to protect a gutter when painting. This design is specific so that it may be placed over the gutter already positioned on ones house without concern whether it will fit as it has a universal shape and not a shape specific to any one gutter. It keeps in position along the gutter as a painter makes their way along a side of a house when painting.

The gutter guard 1 is slidably attached the gutter. By having it be slidably attached to the gutter, the painting professional or contractor can slide it across the gutter, working in sections, until the entire facia of the home is painted. Once the fascia is painted, the painting professional or contractor can easily remove the gutter guard from the residence and use it again at a later date. It works by attaching to the gutter that is already attached to the home. A gutter is usually securely fastened to the house, though the connection to the house is along the top portion of the gutter. Given that the portion of the gutter that hangs from the roof is not secured down, the lower portion creates a space wide enough to allow the gutter guard to be slid into position.

The gutter guard has a base panel 11, a top panel, and a front face 12. This flat base panel 11 abuts the flat base of one's gutter when the gutter guard is attached to the gutter of the home being painted. The base panel 11 comprises a front edge 21 and a rear edge 22. The front face 12 further comprises top edge 33 and a bottom edge 34 and the front face 12 has an exterior 35 surface and an interior surface 36. The top panel 13 has a forward edge 42 and a rearward edge 43.

Protruding from the base panel 11, along the side that comes in contact with the house, is a base lip 23. When in use, the base lip 23 is positioned in the small space between the side of the house and the gutter that is attached to the house. The base lip 23 protrudes from the base panel 11 of the gutter guard slightly and is angled off center from a 90-degree angle. This ensures that the gutter guard will be able to securely envelope the gutter that is attached to the house to ensure that paint does not get on the gutter. the base lip 23 attaching to the rear edge 22 of the base panel 11. The base lip 23 traverses the entire length of the base panel 11.

The gutter guard has a flat intermediary panel 14. The intermediary panel 14 has a first edge 51 and a second edge 52. This intermediary panel 14 allows this gutter guard to be capable of being connected to any gutter that one my come across and ensure it will operate properly. Extending upward from the intermediary panel 14 is the top lip 41. The top lip 41 attaches to the rearward edge 43 of the top panel and the top lip 41 traverses the entire length of the top panel 13.

The intermediary panel 14 and the top panel 13, coupled with the top lip 41, allow the gutter guard to remain secure. The gutter guard further has at least one handle 31 that is centrally attached to the front face 12 of the gutter guard. In the preferred embodiment, the gutter guard will have two handles to allow better leverage when moving the gutter guard along a roofs gutter. The handles are what allow the painter or user of the gutter guard to easily slide the gutter guard along the gutter attached to the residence once the portion of resident facia is painted. The at least one handle 31 has a gripping surface 32. This is the area that allows one to firmly grab the at least one handle 31 when in use.

The bottom edge of the front face 12 is connected to the front edge 21 of the base panel. The first edge 51 of the intermediary panel 14 is connected to the top edge 33 of the front face 12. The forward edge 42 of the top panel 13 is connected to the second edge 52 of the intermediary panel 14.

Although the invention has been explained in relation to its preferred embodiment, it is to be understood that many other possible modifications and variations can be made without departing from the spirit and scope of the invention.

What is claimed is:

1. A gutter guard comprising:
a base panel;
a top panel;
a front face;
the base panel comprising a front edge and a rear edge;
an intermediary panel; and
the intermediary panel comprising a first edge and a second edge

2. The gutter guard as in claim 1:
the base panel further comprising a base lip;
the base lip attaching to the rear edge of the base panel; and
the base lip traversing the entire length of the base panel.

3. The gutter guard as in claim 1 comprising:
the front face comprising a top edge and a bottom edge;
the front face comprising an exterior surface and an interior surface;
at least one handle being positioned about the exterior surface of the front face.

4. The gutter guard as in claim 3 wherein the bottom edge of the front face is connected to the rear edge of the base panel.

5. The gutter guard as in claim 3 wherein the at least one handle has a gripping surface.

6. The gutter guard as in claim 1 comprising:
the top panel having a forward edge and a rearward edge;
the top panel further comprising a top lip;

7. The gutter guard as in claim 6 comprising:
the top lip attaching to the rearward edge of the top panel; and
the top lip traversing the entire length of the top panel.

8. The gutter guard as in claim 3 comprising:
the first edge of the intermediary panel being connected to the top edge of the front face.

9. The gutter guard as in claim 6 wherein the forward edge of the top panel is connected to the second edge of the intermediary panel.

10. A gutter guard comprising:
a base panel;
a top panel;
a front face;
the base panel comprising a front edge and a rear edge;
an intermediary panel; and
the intermediary panel comprising a first edge and a second edge;
at least one handle being positioned about the exterior surface of the front face; and
the front face comprising a top edge and a bottom edge.

11. The watch holder as in claim 9:
the front face comprising an exterior surface and an interior surface;
the base panel further comprising a base lip;
the base lip attaching to the rear edge of the base panel;
the base lip traversing the entire length of the base panel;

12. The gutter guard as in claim 10 comprising:
wherein the bottom edge of the front face is connected to the rear edge of the base panel; and
wherein the at least one handle has a gripping surface.

13. The gutter guard as in claim 10 comprising:
the top panel having a forward edge and a rearward edge;
the top panel further comprising a top lip;
the top lip attaching to the rearward edge of the top panel; and
the top lip traversing the entire length of the top panel.

14. The watch holder as in claim 10 comprising:
the first edge of the intermediary panel being connected to the top edge of the front face; and
wherein the forward edge of the top panel is connected to the second edge of the intermediary panel.
